(19) United States
(12) Patent Application Publication
(10) Pub. No.: US 2004/0134892 A1
(43) Pub. Date: Jul. 15, 2004

(54) Fuel tank and method of making the same

(75) Inventors: Tsuguo Kido, Aichi (JP); Seiji Yamamoto, Aichi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Futaba Industrial Co., Ltd.

(21) Appl. No.: 10/751,698

(22) Filed: Jan. 5, 2004

Related U.S. Application Data
(63) Continuation of application No. PCT/JP02/06653, filed on Jul. 1, 2002.

(30) Foreign Application Priority Data
Jul. 10, 2001 (JP) 2001-209747

(51) Int. Cl. B23K 26/28

(52) U.S. Cl. 219/121.64

(57) ABSTRACT

A fuel tank for an automobile includes a pair of containers formed by drawing a metal plate. Each container has an opening and a flange formed along an edge of the opening. A side wall of the container has a concavo-convex portion shaped to correspond to a component adjacent to the fuel tank. Each flange is formed into a curved configuration conforming to the concavo-convex portion. The flanges are superposed and welded to each other by laser beam welding.

### CROSS-REFERENCE TO RELATED APPLICATIONS

This application is a continuation of International Application No. PCT/JP02/06653, filed Jul. 1, 2002, the disclosure of which is incorporated herein by reference.

### BACKGROUND OF THE INVENTION

The present invention relates to a fuel tank assembled into automobiles and a method of making the same.

### BRIEF SUMMARY OF THE INVENTION

The present invention was made in view of the foregoing and an object thereof is to provide a fuel tank which can reduce limitations in the shape thereof and improve the freedom in the design and a method of making the same.

A method of making a fuel tank in accordance with the present invention is characterized by drawing a metal plate to form a pair of containers, providing, on each container, a concavo-convex portion corresponding to a component adjacent to the fuel tank, forming a flange extending sidewise from an open edge of each container into a curved configuration along the concavo-convex portion, and joining the flanges and carrying out laser welding after the curved configuration.

Furthermore, a fuel tank in accordance with the present invention, which is made by forming flanges on open edges of a pair of containers formed by drawing a metal plate and by welding the flanges into a joined state, is characterized in that each container has a side wall provided with a concavo-convex portion corresponding to a component adjacent to the fuel tank, each flange is formed into a curved configuration conforming to the concavo-convex portion, and the flanges are welded to each other by laser beam welding.

According to the present invention, as described above, the flanges of the paired containers are welded together by laser welding into the fuel tank. Since the laser welding is of the noncontact type, the welder can stay away from the periphery of the welded portion, whereupon the interference can be avoided. Accordingly, the limitation in the configuration of the fuel tank can be reduced as compared with the case where welding is carried out by the conventional seam welding, and accordingly, the freedom in the design can be improved. Consequently, the fuel tank can be formed into a desired configuration, so that a dead space between the fuel tank and the adjacent component can be reduced, whereupon the capacity of the fuel tank can be increased.

Furthermore, the metal plate formed into each container of the fuel tank in accordance with the present invention may be an austenitic stainless steel containing copper. Toughness can be improved particularly when the austenitic stainless steel contains about 2.5 to 3.5 weight % copper relative to the net weight of the steel, whereupon work hardening (strain hardening) due to drawing can be restrained and an anticorrosive property can be improved.

Furthermore, the metal plate formed into each container may be a ferritic stainless steel or SUS436.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of the fuel tank in accordance with one embodiment of the present invention;

FIG. 2 is an exploded perspective view of the fuel tank;

FIG. 3 is a partial sectional view of an upper wall of the container;

FIG. 4 is a sectional plan view of the fuel tank;

FIG. 5 is a graph showing a welding broken region and a material broken region;

FIG. 6 is a perspective view showing an adjacent component provided in a concavity of the fuel tank;

FIG. 7 is a perspective view of a conventional fuel tank;

FIG. 8 is a side section of the conventional fuel tank, showing a conventional method of making the fuel tank; and

FIG. 9 is a sectional plan view of the conventional fuel tank, showing a conventional method of making the fuel tank.

### DETAILED DESCRIPTION OF THE INVENTION

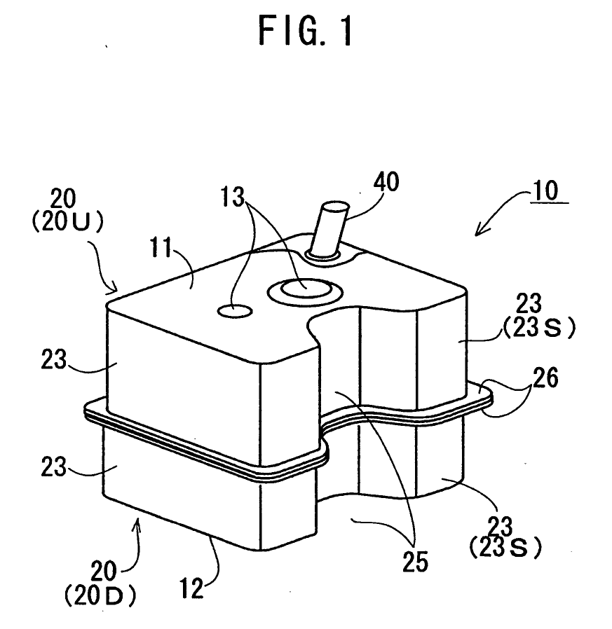

One embodiment of the present invention will be described with reference to FIGS. 1 to 6. A fuel tank 10 of the embodiment has such a structure that open ends of a pair of containers 20 each made of a metal are joined and welded together as shown in FIG. 1.

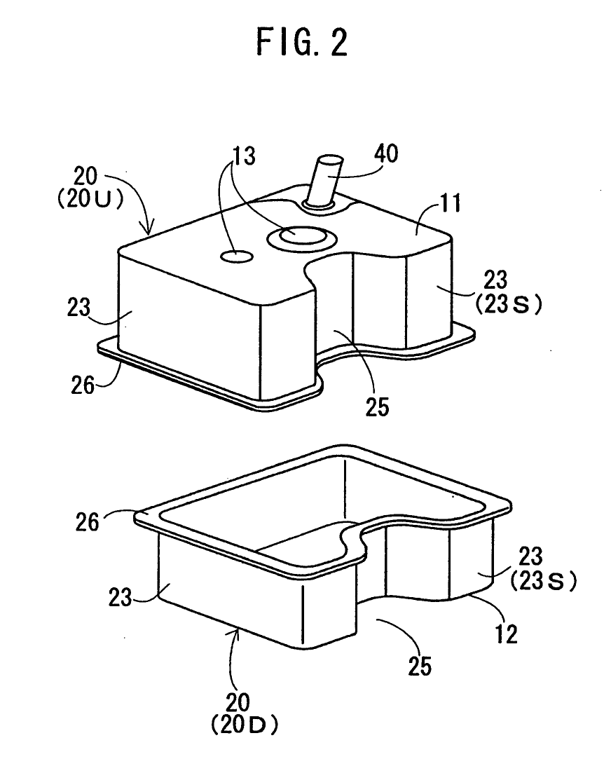

Each container 20 is formed by drawing a metal plate by a press machine, for example. Side walls 23 stand from a bottom wall as shown in FIG. 2.

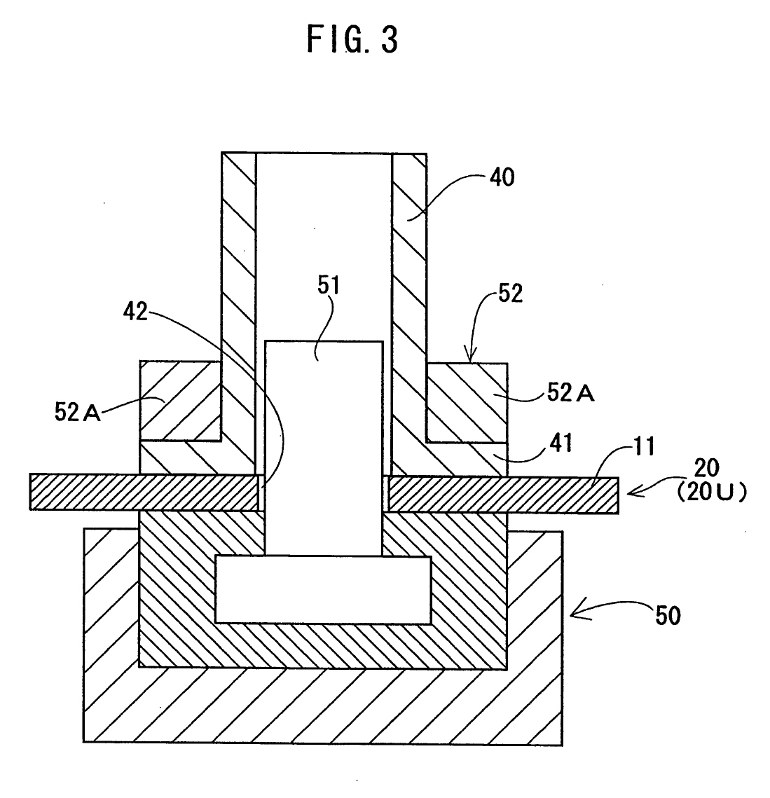

One or the lower container 20 (hereinafter referred to as “lower container 20D”) as viewed in FIG. 2 composes a lower half of the fuel tank 10 and has an approximately flat bottom wall 11. On the other hand, the other or upper container 20 (hereinafter referred to as “upper container 20U”) as viewed in the figure composes an upper half of the fuel tank 10. A bottom wall 12 of the upper container 20U is formed with a plurality of through holes 13 and a cylindrical member 40 stands from the bottom wall 12. The cylindrical member 40 has a flange 41 at one end thereof as shown in FIG. 3. The flange 41 is welded to a peripheral edge of a through hole 42 formed in the upper container 20U.

The side walls 23 of the respective containers 20 have substantially the same structure. More specifically, each container 20 has a plurality of side walls 23 directed on all sides. One side wall 23S is formed with a concavity 25 serving as a concavo-convex portion in the invention. The concavity 25 is defined by a pair of flat inner walls 27 extending from the opening side obliquely inward so as to come near to each other and a flat inside wall 28 provided inside the inner walls 27. Portions between the inner walls 27 and the inside wall 28 are formed into rounded corners respectively.

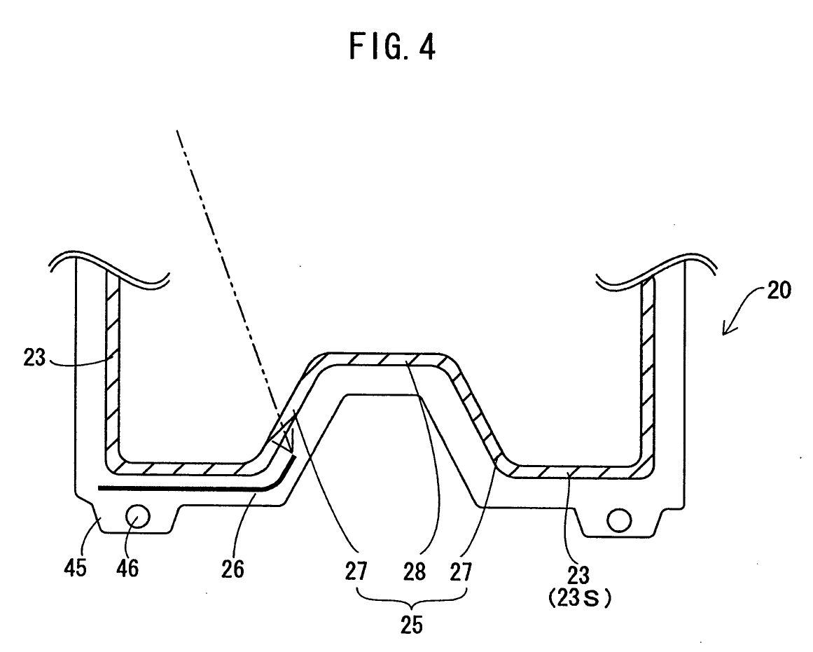

Flanges 26 are formed on open ends of the containers 20 so as to bulge sidewise from the edges of the side walls 23. Each flange 26 has a curved structure corresponding to a configuration of the concavity 25. Each flange 26 is provided with a plurality of wider portions 45 at predetermined locations respectively as shown in FIG. 4. Through fixing holes 46 are formed in the wider portions 45 respectively.

The fuel tank 10 is manufactured by the following manufacturing steps.

A metal plate is set on a pressing machine. In the embodiment, an austenitic stainless steel containing copper but no lead is used as the metal plate. More specifically, the used austenitic stainless steel contains about 2.5 to 3.5 weight % (hereinafter mere “%”) copper, for example 3.2% copper, and other components of 0.01% carbon, 0.4% silicon, 1.6% manganese, 0.002% sulfur, 7.9% nickel, 16.9% chrome and 0.01% nitrogen relative to the net weight of the steel. Furthermore, the metal plate has a thickness of 0.8 mm, for example.

The aforesaid metal plate is punched by a press machine into a predetermined configuration, and the metal plate with the predetermined configuration is drawn so that a pair of containers 20 are formed. Since the metal plate used in the embodiment contains the aforesaid compositions (3.2% copper and the like), the metal plate is superior in the toughness to, for example, SUS304 which is a general austenitic stainless steel, whereupon work hardening due to drawing can be restrained. Consequently, since the fuel tank 10 can be prevented from stress corrosion crack, the fuel tank can conform to a 15-year or 150,000-mile warranty which is a standard of durability of automobiles.

Subsequently, the cylindrical member 40 is welded to the upper container 20U. More specifically, one end of a metal pipe containing the same components as those of the upper container 20U is spread so that the flange 41 is previously formed. The flange 41 is welded to the top of the upper container 20U using a projection welding machine. The projection welding machine is provided with a pin 51 standing on an end face of one circular cylindrical electrode 50 as shown in FIG. 3. The pin 51 is inserted into a through hole 42 formed in the upper container 20U from the interior of the upper container, thereby projecting from the outer face of the upper container 20U. The pin 51 is then inserted through the cylindrical member 40, and the flange 41 is then caused to abut against the circumferential edge of the through hole 42. The other electrode 52 of the projection welding machine is composed of a pair of semicircular arc-shaped electrode members 52A. The electrode members 52A are applied to the flange 41 from the side of the cylindrical member 40, thereby being pressed against the top of the flange 41. When voltage is applied between both electrodes 50 and 52, the abutting faces of the circumferential edge of the through hole 13 and the flange 41 are melted by electric resistance heat.

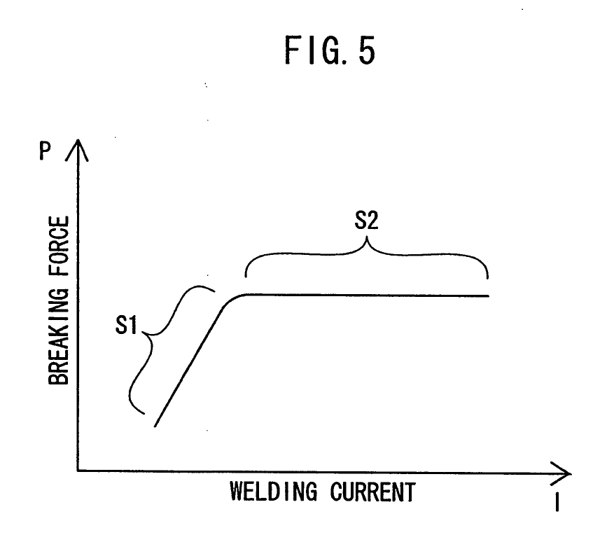

The following effects are achieved when the cylindrical member 40 and the upper container 20U are both made of the metal containing the above components (3.2% copper and the like). That is, the welded cylindrical member 40 and upper container 20U were pulled for inspection of welding strength. The relationship between a pulling force (breaking force) P and a welding current I was obtained when any part was broken. Breaking phenomena in this case include base material breakage in which base materials for the upper container 20 and cylindrical member 40 are broken and welding breakage in which secured portions of the base materials are broken. The welding of the metals both containing the aforesaid components (3.2% copper and the like) is clearly divided into a welding breakage region S1 in which the welding breakage is caused and a base material breakage region S2 in which a base material breakage is caused, on the graph, as shown in FIG. 5. Consequently, the welding current I can be set more easily and the welding quality can be rendered stable.

After the cylindrical member 40 has been welded to the upper container 20U, the upper and lower containers 20U and 20D are set in a jig while the flanges 26 of both containers are joined together. In this case, for example, fixing holes 46 (see FIG. 4) formed in both flanges 26 respectively are aligned and a pin (not shown) is inserted through the fixing holes 46, whereupon both containers 20U and 20D can be set at a normal joining position.

Subsequently, a laser welding machine (not shown) is driven. Then, on the basis of locus data previously stored in the laser welding machine, laser beams emitted from a laser source are reflected on a plurality of driving mirrors such that a point of irradiation of the laser beams (see arrow of two-dot chain line in FIG. 4) is moved along the curvature of the flange 26. Consequently, the base materials of the flanges 26 to which the laser beams have been applied are melted to be welded together. Since the base material is rapidly heated to be melted in a portion where the laser beams have been applied, an area of thermal influence on a periphery of a welded portion is reduced as compared with the case of the seam welding, whereupon prevention of deformation due to heat and rust prevention can be improved. Moreover, since the laser welding machine is of the noncontact type, the interference of the laser welding machine and the side wall 23 with each other can be avoided when the flange 26 is welded in the inner part of the concavity 25. Consequently, the flange 26 can be welded easily in the inner part of the concavity 25.

According to the laser welding, besides, since the laser welding machine is of the noncontact type, the load on the jig can be rendered smaller as compared with the case of a seam welding of the contact type. Furthermore, since differences in the position of the welded portion are smaller in the laser welding than in the seam welding, the width of the flange 26 can be rendered smaller than that in the prior art.

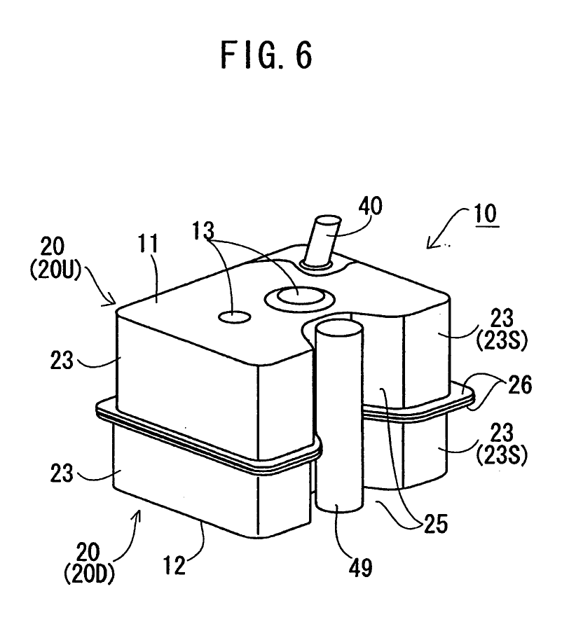

The fuel tank completed through the above-described welding step is fixed at a predetermined location in the automobile body. In this case, as shown in FIG. 6, a component 49 (for example, a canister, a fuel pump, a fuel filter or the like) adjacent to the fuel tank 10 can be disposed in the concavity 25 formed in the fuel tank 10 and accordingly, a dead space between the fuel tank 10 and the adjacent component 49 can be reduced.

Thus, in the embodiment, the flanges 26 of the containers 20 are welded together by the laser welding. Accordingly, the interference of the laser welding machine and the periphery of the welded portion with each other can be avoided and the limitation in the configuration of the fuel tank 10 can be reduced. Consequently, the freedom in the design can be improved and the dead space between the fuel tank and the adjacent component 49 can be reduced by the provision of the concavity 25 of a desired configuration in the fuel tank 10, whereupon the capacity of the fuel tank 10 can be increased. Moreover, when each container 20 is made of the austenitic stainless steel containing 3.2% copper, work hardening due to drawing can be reduced and the anticorrosive property can be improved. Furthermore, the fuel tank 10 is adapted for recent environmental problems since the metal plate contains no lead although the conventional terne-coated carbon steel sheet contains it. After completion of the welding step, an organic coating (cationic electrodeposition coating, for example) is preferably applied to the fuel tank 10 in order that corrosion prevention may be improved in a gap in superposed stainless portions (a gap between flanges 26).

The present invention should not be limited to the above-described embodiment but for example, the following description of embodiment is contained in the technical scope of the present invention. Furthermore, the present invention may be carried out in various modified forms without departing from the essentials other than the following.

That is, the austenitic stainless steel made into the containers of the fuel tank may contain 0.2% copper, 0.02% carbon, 0.6% silicon, 1.6% manganese, 0.005% sulfur, 10.2% nickel, 18.5% chrome and 0.04% nitrogen relative to the net weight of the steel, other than the one explained in the foregoing embodiment.

Furthermore, the metal plate made into the containers of the fuel tank may not necessarily be the austenitic stainless steel. For example, a ferritic stainless steel such as SUS436 may be used. When the ferritic stainless steel is used, the toughness is reduced but the corrosion preventiveness is improved as compared with the austenitic stainless steel.

Furthermore, the metal plate made into the containers of the fuel tank may not necessarily be a stainless steel but may be one of various plated steel plates such as aluminized steel plate, molten galvanized steel plate, zinc alloy plated steel plate or the like. Since plating in the welded portion is peeled off in the case of the plated steel plate, it has been difficult to use the plated steel plate for fuel tanks made by carrying out the conventional seam welding. However, as described above, since an area of thermal influence on a periphery of a welded portion is reduced in the fuel tank made by the laser welding, various plated steel plates are expected to be used as the metal plate made into the containers of the fuel tank.

Furthermore, in the foregoing embodiment, the flange 26 has a rounded and curved configuration according to the concavity 25 of the fuel tank 10. However, the curved configuration may not necessarily be rounded. For example, a mere connection of straight portions is included.

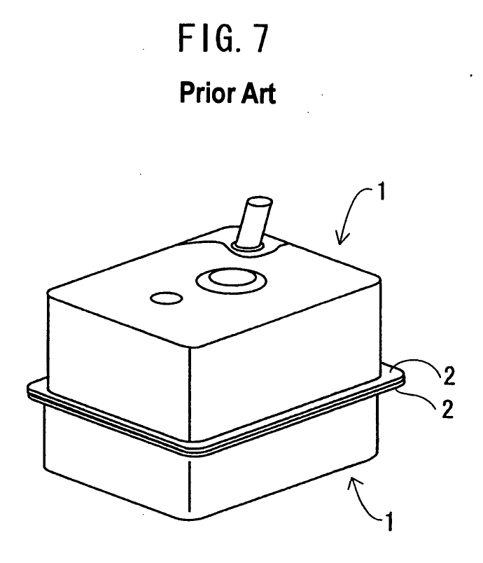

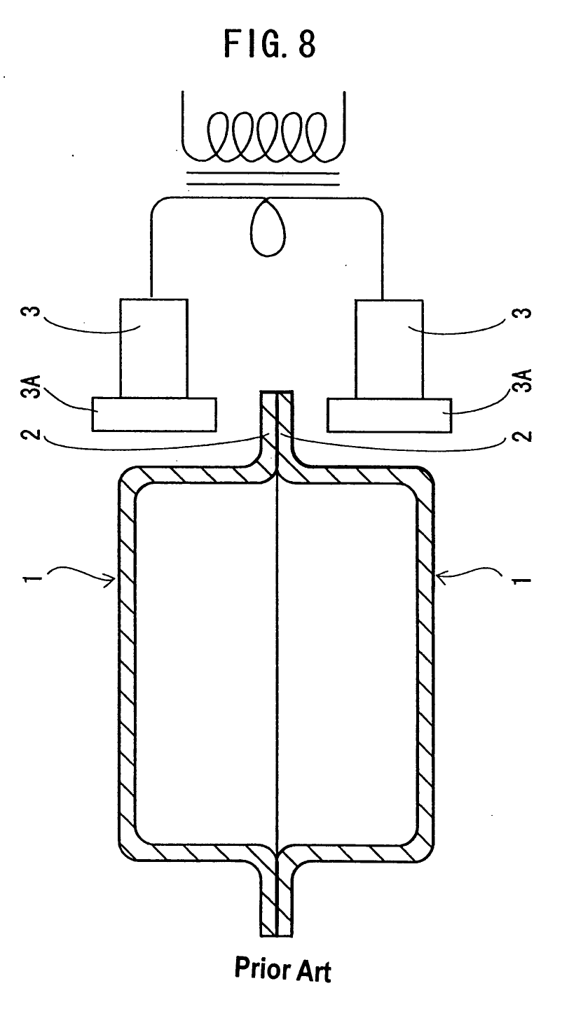

Conventionally, for the purpose of making a fuel tank, a metal plate is drawn to be formed into a pair of containers 1 and flanges 2 formed along open edges of the containers 1 respectively are superposed so that a seam welding is carried out, as shown in FIG. 7. More specifically, the flanges 2 are held by a pair of roller electrodes 3 provided in a seam welder as shown in FIG. 8. Held portions are moved along the flanges 2 while the flanges 2 are welded by electrical resistance heat of the held portions.

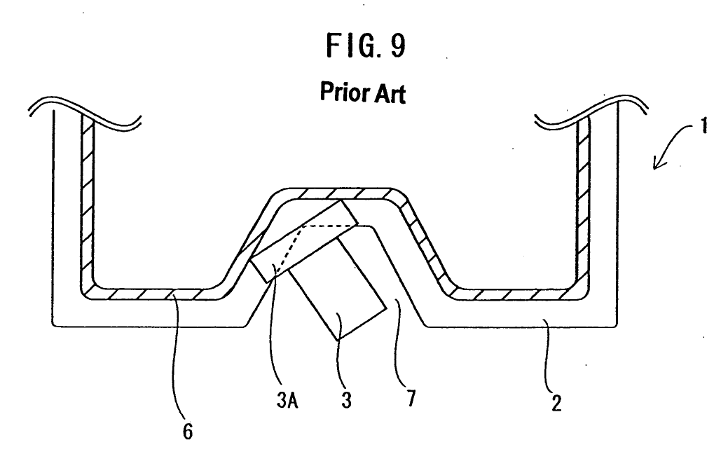

On the other hand, there is a case where a concave portion 7 corresponding to an adjacent component (not shown) is desired to be provided in a side wall 6 of the fuel tank so that a dead space is reduced between the fuel tank and the adjacent component, as shown in FIG. 9.

In the above-described conventional method, however, there can be a case where a roller 3A of the seam welder interferes with the side wall 6 of the container 1 as shown in the same figure when the flanges 2 located at an inner side of the concave portion 7 is welded, whereupon the welding cannot be carried out. Accordingly, there is a problem that the shape of the fuel tank is limited such that the freedom in the design is reduced.

Furthermore, a terne-coated carbon steel sheet is conventionally used as the metal material for the fuel tank with the costs being regarded as important. Since the terne-coated carbon steel sheet contains lead as a component, a study of a lead-free material has been required from a point of environmental problems.

As described above, the present invention is useful as a fuel tank assembled into automobiles and a method of making the same and more particularly suitable for a fuel tank having a complicated configuration and a method of making the same. Furthermore, the present invention is useful for a fuel tank used in the environment where severe corrosion prevention is required.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of making a fuel tank capable of being assembled onto an automobile having a component adjacent to the fuel tank, comprising the steps of:
drawing a metal plate to form a pair of containers, each container having an opening;
providing, on each container, a concavo-convex portion corresponding in shape to the component adjacent to the fuel tank;
forming a flange extending sidewise from the opening of each container in a curved configuration along the concavo-convex portion;
placing the flanges in engagement; and
performing a laser welding process to join the flanges.

2. A fuel tank capable of being assembled onto an automobile body having a component adjacent the fuel tank, the fuel tank comprising:
a pair of containers formed by drawing a metal plate, each container having:
an opening;
a flange formed along an edge of the opening; and
a side wall provided with a concavo-convex portion shaped corresponding to the component adjacent to the fuel tank;
wherein each flange is formed into a curved configuration conforming to the concavo-convex portion; and
wherein the flanges are welded to each other by laser beam welding.

3. The fuel tank according to claim 2, wherein the metal plate formed into each container comprises an austenitic stainless steel containing copper.

4. The fuel tank according to claim 2, wherein the metal plate formed into each container comprises SUS436.
